(19) United States
(12) Patent Application Publication
(10) Pub. No.: US 2004/0083876 A1
(43) Pub. Date: May 6, 2004

(54) Multiple diameter tube wind chime or tubular bell comprised of tubes singularly air resonant tuned for maximum expression of primary frequency

(76) Inventors: Jack William Maegli, Beloit, WI (US); Charles Lloyd Daugherty, Ridgecrest, CA (US)

Correspondence Address: JACK WILLIAM MAEGLI, 713 S. PADDOCK RD, BELOIT, WI, 53511, US

(21) Appl. No.: 10/404,461

(22) Filed: Apr. 1, 2003

Related U.S. Application Data
(60) Provisional application No. 60/424,181, filed on Nov. 6, 2002.

(51) Int. Cl. G10D 13/08

(52) U.S. Cl. 84/410

(57) ABSTRACT

The objective of the embodiment is to maximize amplitude sustentation of the primary (or fundamental) frequency of metal wind chime tubes, while at the same time attenuating undesirable harmonic frequencies. This is accomplished by designing the dimensions of each tube of the chime such that they are in resonance with the standing air wave inside the tube. To achieve maximum resonance it has been observed that there is maximum amplitude sustentation with time when the tube dimensions are such that the length of the tube approximates the second natural air column wave length. At this length equivalency there is a wave node match between the second natural frequency of the air column inside the tube and that of the primary natural frequency wave of the tube. The constructive interference thus accomplished supports the primary frequency of the tube and by such attenuates expression of harmonic frequencies. The tubular dimension requisite to establish said wave length match expressed by length to diameter ratio (L/D) defines what the author's term an “ideal tube”.

### FIELD OF THE INVENTION

This invention relates to musical wind chimes or wind bells.

### BACKGROUND OF THE INVENTION

In a conventional wind chime the diameter of the tube remains fixed, and the artist cuts the tubes to varying lengths to establish the desired frequencies (or notes). Since the fundamental vibrational node of a tube occurs at 22.4% of the tube length from each end, the tubes are usually suspended at the upper node point to reduce attenuation caused by energy wasted vibrating the suspension device.

It can be observed that some tubes adjusted using only length (usually the shorter ones) have an attenuated ring and others (usually the longer ones) have undesirable secondary harmonic frequency expression. These resonant frequency expressions are undesirable in metal tubes because they occur at discordant 2.75× frequency multiples (non-octave resonance) with respect to the primary frequency and thus sound like noise. In extremely long tubes it is possible to have only resonant frequencies generated and an absence of the fundamental. A further defect of secondary resonant expression is relocation of vibrational node causing attenuation from energy lost vibrating the suspension device. It is most desirable to have a chime tube that only generates the fundamental frequency and has a sustained ring. The following patents have tried to address such issues in chimes and tubular bells.

Patent 485,542 describes a method to produce higher quality sounding chime tubes by stiffening or re-enforcing them at specific points. This was accomplished empirically and probably worked by forcing a node in the vibrating metal at such a point(s) to support the fundamental or desirable resonant frequency. It is the authors' experience that while such a practice works, said long tubes attenuate rapidly because they are not at a state of least free energy (the tube is probably attempting to vibrate at points of re-enforcement and frictional energy is lost).

Patent 656,603 describes a method for capping a metallic tube on both ends with a diaphragm disc containing an aperture hole to buffer undesirable frequencies. While this practice attenuates undesirable frequencies, unless the tube is cut to the proper dimension, the fundamental will be dampened as well.

Patent 1,100,671 describes using tube diameter and thickness to reduce undesirable resonant frequencies (increasing both proportional to decreasing frequency). While this is a well founded concept, the results were strictly empirical, and the length to diameter (L/D) ratio of the tubes were approximately 30, which the authors find unacceptably high to reduce resonant frequencies. Counterweights hung from the lower node of the tubes described in the patent had to be used in addition to force the desirable fundamental frequency (node). At this L/D ratio secondary resonant vibrations attempting to vibrate the counterweight at the fundamental node would have quickly lowered the kinetic energy of the tube and thus shortened the duration of the fundamental.

Use of the air column within a vibrating resonator tube to support the fundamental frequency was the object of patent 1,595,359, which describes the use of “fibre” singular diameter resonator tubes employed with a strikable bar musical instrument. The resonating tubes use constructive interference from the air column within to support tube sympathetic vibration induced by sound waves from the bars struck above. A hole is cut in the longitudinal center of the tube in the direction of the bar, to translate sound waves back to the bars. The tubes are capped on both ends presumably to force a node in the air column at these points and thus an antinode in the center creating reflective air waves through the center hole at a resonant match of tube length to ½ air wavelength (this is speculated by the current patent's authors). The author of this patent presents no design formulation, and while not a chime tube, it is an interesting first note of air column reenforcement of a vibrating tube.

Patent 2,559,334 describes the use of a tube capped on both ends, with a aperture hole cut in the longitudinal center of the tube (to emit sound waves) similar to patent 1,595,359, but as a stand alone chime tube. The author states that the intention is to maximize sound emission from the aperture hole with resonant support from the tubular vibration. No relationship is given to L/D geometrical optimization of the tube. Similar to patent 656,603 aperture holes cut in the end caps along with end cap mass is used to adjust frequency. Unfortunately this practice will dampen amplitude sustentation of the fundamental if the tube geometry is incorrect. No formulation is given for determining tube geometry.

JW Stannard Company offers the “trilogy series” of wind chimes offering three sets of tube diameters, each set containing 3 to 5 tubes and hung at a different heights, to accomplish a 2-3 octave span of musical notes. While this use of multiple diameter tubes is a creative solution to spanning multiple octaves, no attempt is made to optimize each tube within the set to the “ideal” dimensions described in the present invention. Instead the conventional approach of tuning by length only is used within each set.

### BRIEF DESCRIPTION OF THE INVENTION

It is the object of this invention to utilize the air column of a tube open at both ends (which is typical of a chime tube) to support the free vibration of the tube at fundamental frequency. A successful execution manifests maximum amplitude sustentation of the primary (or fundamental) frequency, while at the same time attenuating undesirable harmonic frequencies.

To achieve maximum resonance it has been observed that there is maximum amplitude sustentation when the tube dimensions are such that the length of the tube approximates the second natural air column wave length. At this length equivalency in a tube open at both ends there is a wave node match between the second natural frequency of the air column inside the tube and that of the primary natural frequency wave of the tube. The tubular dimension requisite to establish said wave length match expressed by length to diameter ratio (L/D) defines what the authors' term an “ideal tube”. The ideal L/D ratio is contingent on tube material constants and best defines the most important relative geometrical attribute.

It can be empirically demonstrated that with tube dimensions progressively above ideal L/D (see FIG. 3), undesirable harmonic frequency expression increases in amplitude and duration. Energy used for this harmonic expression cannibalizes the amplitude and duration of primary frequency and at progressively longer dimensions expression of the primary disappears altogether. In this case 5A represents the tube tuned to ideal dimension. It has a primary frequency of 880 Hz (1) and secondary of 2423 Hz (4). 5E is 3 notes below ideal with a respective primary and secondary frequency of 659 Hz (2) and 1816 Hz (5), and 5D is 4 notes below ideal with respective primary and secondary frequencies of 587 Hz (3) and 1618 Hz (6). All measurements were made with a computer running an AMD Athalon 1600 processor and SoundBlaster 512 sound card using a Labtec AM-32 microphone and Spectrogram 7.2 software (Richard Horne/Visualization Software LLC). The microphone was located 12″ from the tubes that were arranged in a 30 degree arc equidistant, for equal representation of sound intensity.

At dimensions progressively below ideal L/D (see FIG. 4) the primary frequency suffers increasing attenuation, becoming shorter in duration than with ideal L/D. In this case 5A represents the tube tuned to ideal dimension with a respective primary and secondary frequency of 880 Hz (1) and 2424 Hz (4), 6D is 3 notes above ideal with a respective primary and secondary frequency of 1175 Hz (2) and 3235 Hz (5), and 6E is 4 notes above ideal with a respective primary and secondary frequency of 1318 Hz (3) and 3632 Hz (6). As can be seen, representation of the secondary resonance is negligible below ideal L/D.

The ideal LID ratio then describes the dimension of a wind chime tube that has maximum primary amplitude sustentation with a minimum expression of harmonic frequencies. FIG. 5 shows an example of the long and consistent duration of fundamental (1-6) and short lived corresponding secondary resonant frequencies (7-11) of a typical chime tube set containing said tubes. This is a representation of the tubes given in an example of practicing the preferred embodiment that follows.

It can be realized by one familiar in the art that by varying the diameter of the tubes, and keeping the “ideal” dimension defined above, a multitude of frequencies (notes) can be created. It is the purpose of this invention to propose a wind chime comprised of multiple tubes of varying diameters such that each tube is as close to the ideal dimension as possible. This contrasts to the familiar art of varying the length of tubes with a singular diameter to achieve the notes desired. It is readily apparent to someone familiar in the art that the same concept of an ideal tube could be applied to a singular tubular bell.

### BRIEF DESCRIPTION OF THE DRAWINGS

FIG. 1 represents a general practicing embodiment of the invention, showing 3 different tube diameters with lengths to approximate ideal tube geometry used to span a one octave scale.

FIG. 2 represents a second practicing embodiment of the invention in the form of a tubular wind bell.

FIG. 3 shows amplitude (intensity represented in gray scale) over time of 3 aluminum tubes, representing the notes 5A (880 Hz), 5E (660 Hz), and 5D (587 Hz). In this case 5A represents the tube tuned to ideal dimension, 5E is 3 notes below ideal, and 5D is 4 notes below ideal. All tubes have an outer diameter of 0.835″ and an inner diameter of 0.635″ and respective lengths of 14.76″, 19.71″, and 22.12″.

FIG. 4 shows amplitude (intensity represented in gray scale) over time of 3 aluminum tubes, representing the notes 5A (880 Hz), 6D (1175 Hz), and 6E (1319 Hz). In this case 5A represents the tube tuned to ideal dimension, 6D is 3 notes above ideal, and 6E is 4 notes above ideal. All tubes have an outer diameter of 0.835″ and an inner diameter of 0.635″ and respective lengths of 14.76″, 11.06″, and 9.85″.

FIG. 5 shows amplitude (intensity represented in gray scale) over time of an embodiment of the invention, in this case a wind chime composed of 6 aluminum tubes representing notes (with associated dimensions in the order of outer diameter, inner diameter, and length) of 4A (1.635″, 1.375″, 29.11″), 5C (1.635″, 1.375″, 27.45″), 5D (1.310″, 1.060″, 23.12″), 5E (1.310″, 1.060″, 21.11″), 5G (1.040″, 0.830″, 17.12″), and 5A (1.040″, 0.830″, 16.24″).

FIG. 6 represents a plot of the first natural tube frequency vs. length and the 2^{nd} air column frequency vs. length for an aluminum tube with outer and inner diameters of 1.635″ and 1.375″. The intercept of the two plots defines ideal length.

FIG. 7 represents a plot of the first natural tube frequency vs. length and the 2^{nd} air column frequency vs. length for an aluminum tube with outer and inner diameters of 1.310″ and 1.060″. The intercept of the two plots defines ideal length.

FIG. 8 represents a plot of the first natural tube frequency vs. length and the 2^{nd} air column frequency vs. length for an aluminum tube with outer and inner diameters of 1.040″ and 0.830″. The intercept of the two plots defines ideal length.

FIG. 9 represents a plot of the first natural tube frequency vs. length and the 2^{nd} air column frequency vs. length for an aluminum tube with outer and inner diameters of 0.835″ and 0.635″. The intercept of the two plots defines ideal length.

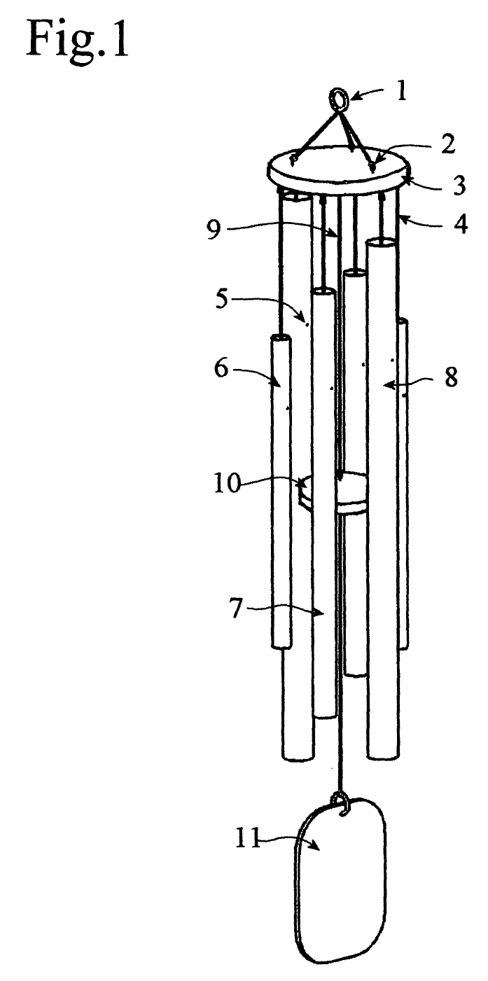

### DETAILED DESCRIPTION OF THE INVENTION

As stated the objective of an ideal chime tube is a geometry that will utilize constructive interference between the second natural frequency of the air column to the primary vibration of the tube. This geometry can be derived from the following explanation.

The formula for the air column frequency in an open tube is:

f=n*vₐ/2*λₐᵢᵣ=n*vₐ/(2*(L+0.6ID))

where:

n=mode number (n=1, 2, 3, . . .)

f=frequency (Hz)

vₐ=speed of sound in air

λₐᵢᵣ=wavelength of air

L=length of the tube

ID=inner diameter of the tube

In practice the antinode of the air column is 0.6 times the inner radius outside the tube on both ends leading to the substitution of (L+0.6*ID) for λₐᵢᵣ.

The formula for the tube frequency is:

f=(B*1)\hat{ }2 * SQRT(g*E*I/(rho*L\hat{ }4))/2*PI

where:

f=frequency

g=gravity

E=Young's modulus of elasticity

I=area moment of inertia, or =PI/64*(OD\hat{ }4-ID\hat{ }4)

rho=mass per unit length, or =SQRT(OD\hat{ }2-ID\hat{ }2)*d, where d is density

L=length of tube

(B*1)\hat{ }2=Euler's constants based on the boundary conditions, for a wind chime (Free-Free Beam):

(B₁*1)\hat{ }2=22.4 for the first natural frequency.

(B₂*1)\hat{ }2=61.7 for the second natural frequency.

(B₃*1)\hat{ }2=121 for the third natural frequency

At such a point where the tube has constructive resonant interference, the following conditions should apply: fₐᵢᵣ=f_{tube} and λₐᵢᵣ=L_{tube}+0.6*ID as previously described. Solving for the relative dimensions of said tube with these assumptions and using the 1st mode of the tube frequency and the second mode of the air column for constructive interference:

(B₁*1)\hat{ }2 * SQRT(g*E*I/(rho*L\hat{ }4))/2*PI=vₐ/(L+0.6*ID)

This equation can be reduced to two variables (length and diameter) to define the geometry of such a tube, the other values being physical or material constants. For the purpose of representing this dimension as a ratio of length to diameter we will approximate I as (PI/8)*D\hat{ }3*t where D is mean diameter and t is thickness of the tube wall. We will also approximate rho with the mass per unit length expression: rho=PI*D*t*d, and substitute (D−t) for ID, leading to:

(B₁*1)\hat{ }2 * SQRT(g*E*D\hat{ }2)/(8*d*L\hat{ }4))/2*PI=vₐ/(L+0.6*(D−t))

Or:

Ideal Length=(C+SQRT(C\hat{ }2+4*0.6*(D−t)*C))/2

where:

C=(((B₁*1)\hat{ }2)/(2*vₐ*PI))*D*SQRT((g*E)/(8 *d))

Solving for L using material constants for aluminum (E=1.0 * 10\hat{ }7 lb/in\hat{ }2; d=0.100 lb/in\hat{ }3), or steel (E=3.0 * 10\hat{ }7 lb/in\hat{ }2; d=0.283 lb/in\hat{ }3), the length to diameter ratio for a thin wall tube is:

L/D≈19

For copper the ratio is smaller because ratio of Young's modulus of elasticity to the density is smaller (E=1.7 * 10\hat{ }7 lb/in\hat{ }2; d=0.322 lb/in\hat{ }3)

L/D≈13

By varying the diameter of the tubes, and keeping the “ideal” dimension defined above, a multitude of frequencies (notes) can be created.

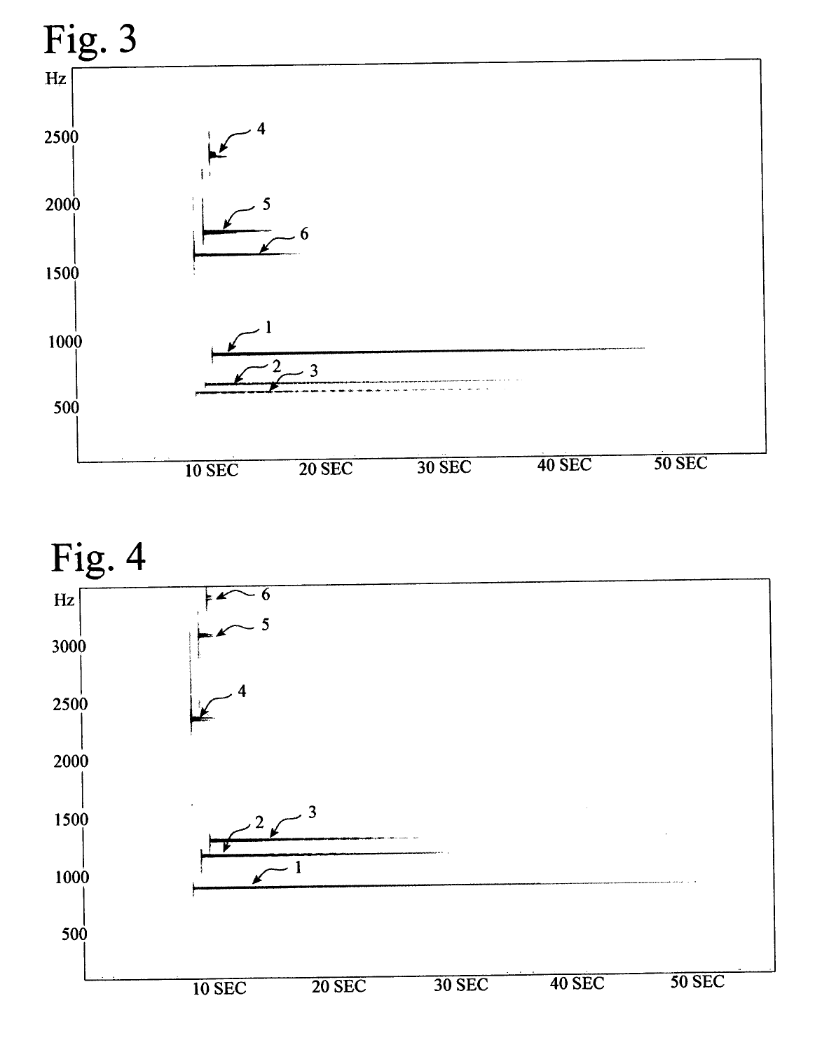

FIG. 3 represents the result when the L/D ratio goes tangibly above ideal. In this case the ring of an ideal tube, represented by 5A (880 Hz) is long in duration compared to longer than ideal tubes representing the notes 5E (659 Hz) and 5D (587 Hz), which are 3 and 4 notes respectively below ideal.

The tubes were struck about 0.5 seconds apart (from lowest to highest note) so harmonic frequencies could be associated with each tube. In this case the second harmonic of 5A manifests at 2423 Hz, 5E: 1816 Hz, and 5D: 1618 Hz.

As can be seen, when tubes of the same diameter of progressively lower primary frequency compared to ideal dimension are struck, manifestation and duration of second harmonic amplitude increase. This can likewise be associated with attenuation of their respective primary frequency.

FIG. 4 represents the result when the L/D ratio goes tangibly below ideal. In this case the ring of an ideal tube represented by 5A (880 Hz) is long in duration compared to shorter than ideal tubes representing the notes 6D (1175 Hz) and 6E (1318 Hz), which are 3 and 4 notes respectively above ideal.

The tubes were struck about 0.5 seconds apart (from lowest to highest note) so harmonic frequencies could be associated with each tube. As can be seen, when the tubes of progressively higher primary frequency compared to ideal dimension are struck sustentation of the primary frequency amplitude diminishes. Harmonic frequency generation at or below the ideal tube dimension is negligible.

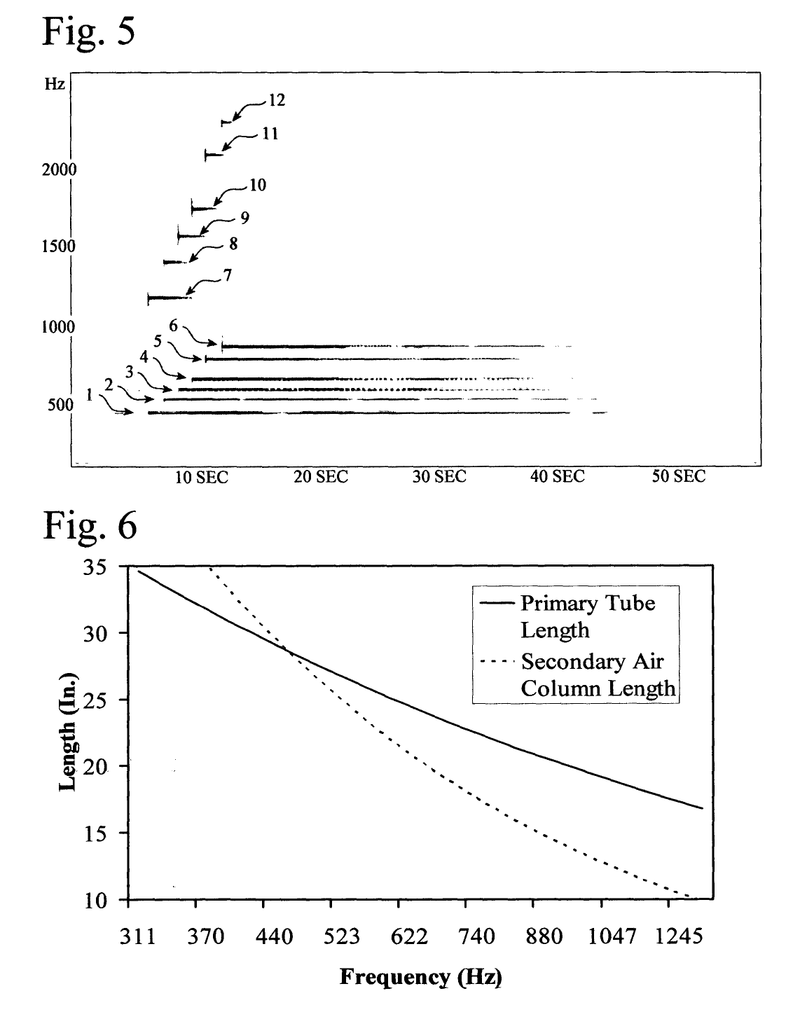

FIG. 5 represents an embodiment of the invention, in this case a wind chime composed of 6 ideal tubes spanning a one octave scale, representing the notes: 4A, 440 Hz; 5C, 523 Hz; 5D, 587 Hz; 5E, 659 Hz; 5G, 784 Hz; and 5A, 880 Hz. As can be seen, resonant amplitudes are short lived and sustentation of the primary frequency is long and consistent in all tubes.

### General Example of Practicing the Preferred Embodiment

It is most pragmatic for the practitioner of this invention to first pick a material (Aluminum, steel, copper) and then assess the commercially available diameters of tubes available. The authors prefer the sound of aluminum and steel tubes. Each diameter, contingent on its material composition will have its own specific “ideal” length, and thus “ideal” frequency. It is desired to start a single octave chime with the lowest note of the scale closest to the “ideal” frequency of the largest diameter tube available. To maintain good resonance it is not recommended to depart more than 2 notes from that representing the “ideal” frequency. A simple way of determining what the ideal frequency is for a particular tube is to graphically plot primary frequency versus tube length for a commercially available tube with the equation: f=((B₁*1)\hat{ }2 * SQRT (E*I/(rho*L\hat{ }4)))/2*PI. Another curve is plotted with the aforesaid but to represent frequency versus the second natural air column wavelength utilizing: f=vₐ/λₐᵢᵣ, where λₐᵢᵣ is plotted as an expression of tube length: L=λₐᵢᵣ −0.6ID. Frequency and length of the two respective curves are plotted on the same axis. The intersect of the curves representing the two equations defines both the length and “ideal” frequency of the tube selected.

The next step is determining what chord or scale the practitioner wants represented in the wind chime. It is not the purpose of this disclosure to discuss the multitude of harmonic scales available, but it is most common in the art of wind chime making to represent 5 to 6 notes within a single octave that have a pleasing sound when all ringing.

As described above, a separate plot should be made for the next smaller diameter commercial tubes available. When moving up the scale selected, the frequency or note desired will be represented closer to the “ideal” frequency of the next smaller diameter tube rather than that of the starting diameter. It is at this point that the practitioner employs a smaller diameter tube to maintain maximum advantage of the invention.

This process is continued until the full chord or scale desired is represented. It is common to have 3-5 tube diameters utilized to complete a single octave chime.

The aforementioned tubes are preferably hung from the upper node point (or point of least kinetic displacement) of the vibrating tube, which is 22.4% the length of the tube from the upper end. As a note, the lower node occurs symmetrically 22.4% the length of the tube from the bottom end, but is of little value unless constraining both ends of the tubes for use in a musical instrument or the like. The tubes may be hung by drilling holes through both sides to accept a suspension line passing through the tube (preferably made of multi-weave Dacron or other UV resistant fiber allowing prolonged outdoor use). An alternative method of hanging the tubes is to insert a dowel of similar material to the tubes through the nodal drill holes and by bending upwards in the center, or cutting a medial groove, create a single point at the cross dimensional center of the tube to accept a suspension line.

A supportive structure should be made of wood or metal to accept the suspension lines described above and hold all tubes within a fixed radius equidistant of a centrally located clapper. The clapper is hung from the central point of this radius and is usually of such a diameter to give a distance of 0.75″ to 1.5″ to the suspended tubes. A short distance provides a softer or slower strike since less time is provided for clapper acceleration (from wind blowing the sail) from the concentric point, but allows strikes under low wind conditions. A larger distance provides harder or faster strike, but demands higher wind conditions to do so. The sail, which is hung via a suspension line below the clapper, must be of appropriate cross section to be accelerated by local wind conditions, and must be of sufficient mass to translate appropriate kinetic energy to the clapper. It is advised to have a sail which is at least 20% the mass of the clapper.

### Specific Example of Practicing the Preferred Embodiment in the Form of an Aluminum Wind Chime

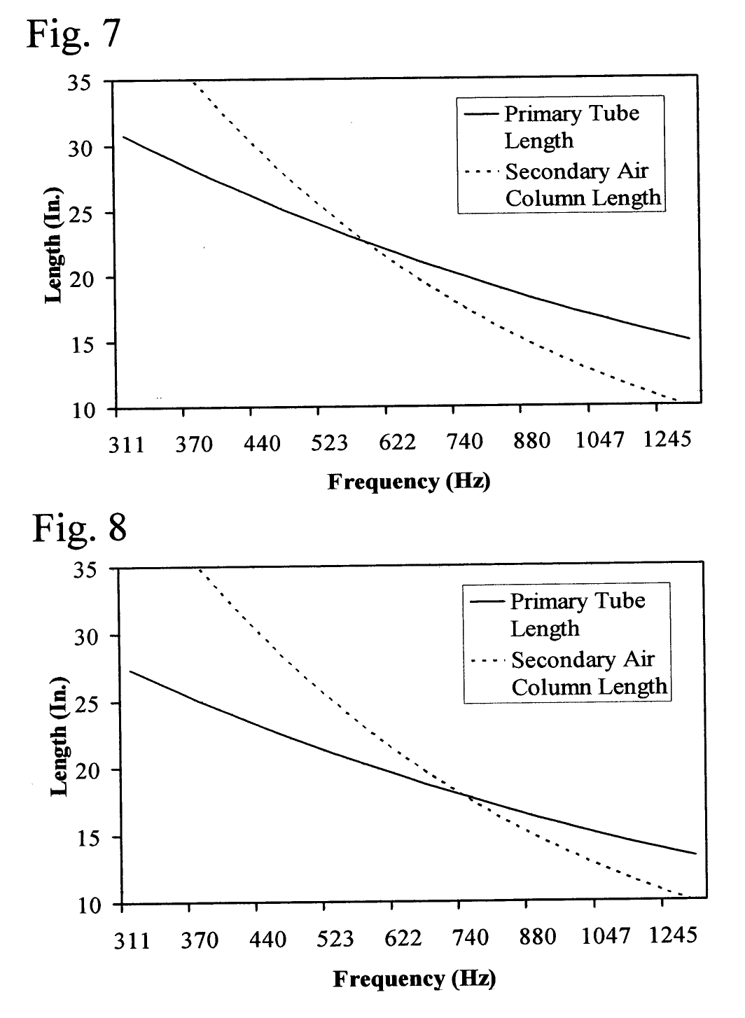

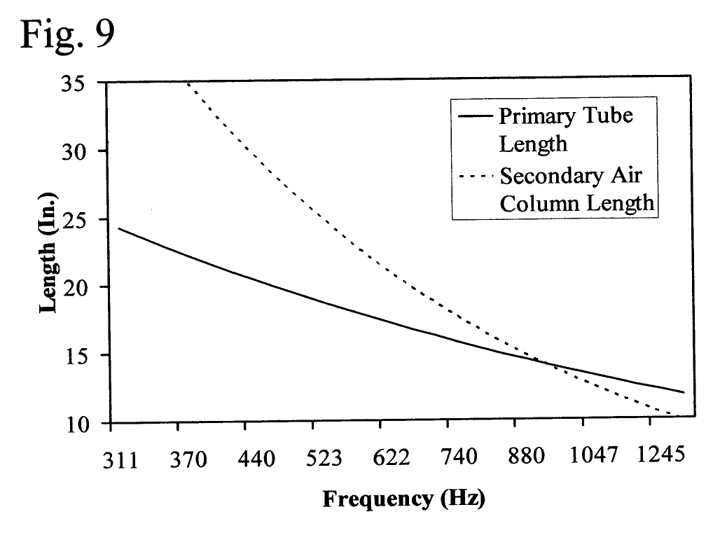

From Easco Aluminum (706 S. State St., Girard Ohio, 44420) 10′ aluminum tubes were procured with the following outer and inner diameters: 1.635″, 1.375″; 1.310″, 1.060″; 1.040″, 0.830″; and 0.835,″ 0.635″. Ideal length was determined by the intercept (expressed as tube length) of the plot of the first natural tube frequency vs length and the 2^{nd} air column frequency vs. length (as previously described) for the three tubes in the order listed above. The intercept length was approximately: 29.91″ (FIG. 6), 23.77″ (FIG. 7), 17.77″ (FIG. 8), and 14.13″ (FIG. 9) respectively. Corresponding closest whole note and frequencies at these respective lengths were: 4A, 440 Hz; 5C, 523 Hz; 5F, 698 Hz, and 5A, 880 Hz. Starting with the largest tube, the lowest note of the scale would thus be 4A, as it accurately represents ideal length. Using a pentatonic minor scale starting in 4A, the following notes and frequencies then needed representation: 4A, 440 Hz; 5C, 528 Hz; 5D, 587 Hz; 5E, 660 Hz; 5G, 792 Hz; and 5A, 880 Hz. The following tubes were then selected and lengths cut to represent notes of the scale while maintaining as close as possible a relationship to the ideal length (or corresponding frequency):

| | Frequency | Tube OD | Tube ID | Length | Node | |
|---|---|---|---|---|---|---|
| Note | (Hz) | (in) | (in) | (in) | (in) | L/D |
| 4A | 440.00 | 1.63 | 1.37 | 29.11 | 6.52 | 19.34 |
| 5C | 528.00 | 1.31 | 1.06 | 23.71 | 5.31 | 20.01 |
| 5D | 587.00 | 1.31 | 1.06 | 22.38 | 5.01 | 18.89 |
| 5E | 660.00 | 1.31 | 1.06 | 21.12 | 4.73 | 17.82 |
| 5G | 792.00 | 1.04 | 0.83 | 17.21 | 3.86 | 18.41 |
| 5A | 880.00 | 0.84 | 0.64 | 14.42 | 3.23 | 19.62 |

The tubes were then assembled in the fashion described in the preceding section to finish the wind chime.

### Specific Example of Practicing the Preferred Embodiment in the Form of a Copper Tubular Bell

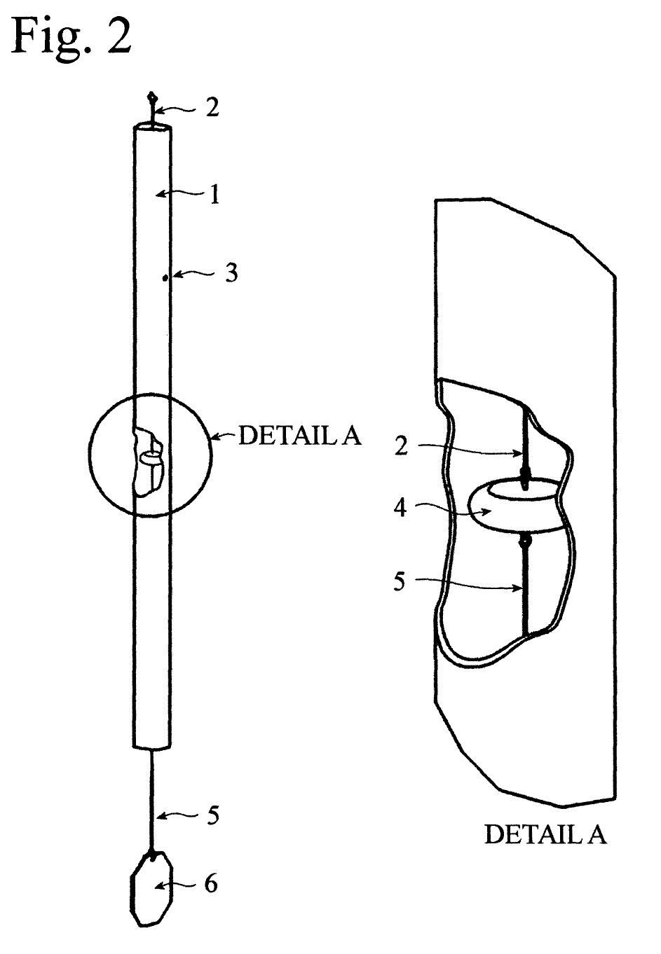

A 12′ length of 4.125″ O.D., 3.935″ I.D. type M copper tubing was procured from United States Brass and Copper (Downers Grove, Ill.). By doing a plot as described in the previous example, the metal/secondary air column intercept length was determined to be 58.1″. The closest whole note to this length is 3A (220 Hz). Referencing FIG. 2, to represent this note the tube (1) was cut to a length of 57.4″. Since this is a heavy tube (22 lbs) a ¼″ hole (3) was drilled at the suspension node (12.9″ from the top) on both sides and a ¼″ piece of copper rod stock was used as a hanger. The rod stock was notched in the middle to tie the suspension line to and position at center of the tube. It was cut slightly longer than the tube O.D. so the ends could be flared with a mallet to hold in place. This joint was fluxed, heated and silver soldered for added strength, then ground flush with the tube. A suspension line (2) consisting of high strength Dacron multi-weave fiber was attached to a hanging ring and the clapper (4). Another segment of line (5) was used to attach the sail (6) to the clapper. In this case the clapper was made of ¾″ oak cut to a diameter of 2.40″ to give a ¾″ swing to impact distance of the tube. The sail was a 5″×5″ octagon cut of 1/16″ copper flat stock.

What we claim is:

1: A wind chime comprised of a plurality of tubular metallic members such that each approximates the optimum length to diameter ratio for the material of composition for purposes of constructive resonance with the second natural air column frequency inside the tube, manifesting when struck, a sustained primary frequency amplitude and attenuated harmonic frequency amplitudes.

2: The embodiment of claim 1 in which the chime is composed of aluminum or steel and all tubes have a length to diameter ratio of 16-21.

3: The embodiment of claim 1 in which the chime is composed of copper and all tubes have a length to diameter ratio of 11-15.

4: The preferred embodiment of claim 2 in which the chime is composed of aluminum or steel and all tubes have a length to diameter ratio of approximately 19.

5: The preferred embodiment of claim 3 in which the chime is composed of copper and all tubes have a length to diameter ratio of approximately 13.

6: A tubular wind bell comprised of a tubular metallic member such that it intentionally approximates the optimum length to diameter ratio to maximize amplitude sustentation of the primary frequency and attenuate resonant frequencies.

7: The embodiment of claim 6 in which the tube is composed of aluminum or steel and has a length to diameter ratio of 16-21.

8: The embodiment of claim 6 in which the tube is composed of copper and has a length to diameter ratio of 11-15.

9: The preferred embodiment of claim 7 in which the tube is composed of aluminum or steel and has a length to diameter ratio of approximately 19.

10: The preferred embodiment of claim 8 in which the tube is composed of copper and has a length to diameter ratio of approximately 13.
